(19) United States
(12) Patent Application Publication
(10) Pub. No.: US 2022/0182100 A1
(43) Pub. Date: Jun. 9, 2022

(54) SYSTEM AND METHOD FOR INTERACTIVE COMMUNICATION

(71) Applicant: Leigh Rothschild, Miami, FL (US)

(72) Inventor: Leigh Rothschild, Miami, FL (US)

(21) Appl. No.: 16/888,074

(22) Filed: May 29, 2020

(51) Int. Cl. H04B 5/00; H04L 5/00; H04W 4/80; H04W 4/70

(52) U.S. Cl. CPC H04B 5/0031; H04L 5/0048; H04W 4/23; H04W 4/70; H04W 4/80

(57) ABSTRACT

The present invention provides a communication system including a transmitting including a transmitting device and a receiving device. The transmitting device includes a first processor, a first communication module and a first display module. Further, the receiving device includes a second processor, a second communications module and a second display that is communicatively connected to the second processor. The first processor is configured to Identify if the receiving device within a proximate distance, determine a reception status of the receiving device, read a plurality of reception parameters of the receiving device, determining a reception mode of the receiving device, prepare a content to be transmitted to the receiving device based on the reception parameters, initiating a communication channel with the receiving device; and transmit the content to the receiving device based on the reception parameters and the reception mode.

### FIELD OF INVENTION

The present invention relates to a system and method for a communication. More particularly, to a system and method for a communication between a receiving device and a transmitting device in an interactive manner.

### BACKGROUND OF THE INVENTION

Across the world billboards (signage) exist on most roads and highways and provide an excellent opportunity of advertising. Generally, the billboards are placed there by advertisers to educate consumers and/or to advertise products. Some signage also relates to safety issues (such as conditions or instructions for driving the roadway or highway).

Current billboards can be seen but as one is travelling in a vehicle at a certain speed the time viewing the billboard/signage is a very short period of time. A standard principal of advertising is to make the user have repeated impressions of whatever information you are trying to convey and reinforce. Yet, with a single billboard viewed quite quickly by the user, the impression is very short and in the case of one billboard singular. This is not good for the billboard/signage owner and not good for the person viewing the billboard/signage.

There is currently no communication channel or interactive channel between billboards/signage and users. Thus, there is a need for a system and method using technology that allows a user to instantly capture message of a billboard/signage, and further to be able to go deeper into the subject matter of the billboard/signage with an opportunity to interact with the billboard/signage.

### BRIEF DESCRIPTION OF DRAWINGS

The following detailed description of various embodiments is better understood when read in conjunction with the drawings provided herein. For illustrative purposes, exemplary embodiments are shown in the drawings; however, the presently disclosed subject matter is not limited to the specific systems and methods shown in those embodiments

FIG. 1 is a block diagram of a system for a communication, in accordance with an embodiment of the invention.

FIG. 2 is a block diagram of a system for a communication, in accordance with another embodiment of the invention.

FIG. 3 is a flow chart depicting a method for communication, in accordance with an embodiment of the invention.

FIG. 4 is a flow chart depicting a method for communication, in accordance with another embodiment of the invention.

### DETAILED DESCRIPTION OF INVENTION

The present invention provides a solution for providing a bisynchronous communication between a billboard signage and a user device particularly a handheld device like smartphone, smartwatch, a laptop, an infotainment unit of a vehicle or a tablet computer.

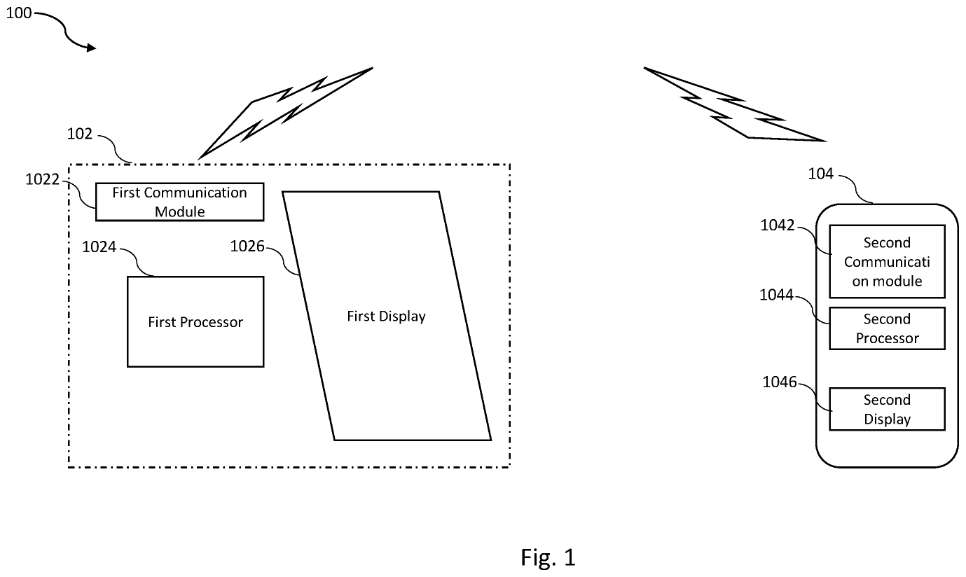

Referring to FIG. 1, a block diagram, illustrates a communication system 100 (referred to as the system 100 hereinafter), in accordance with an embodiment of the invention. The system 100 includes a transmitting device 102 and a receiving device 104. According to an embodiment of the invention, the transmitting device 102 may be a billboard signage or any other means of advertising to general public at a public place or road. According to another embodiment of the invention the receiving device 104 may be any one of a smartphone, a smartwatch, a laptop, an infotainment unit, or a tablet computer.

The transmitting device 102 may include a first processor 1024, a first communication module 1022, and a first display module 1026. The receiving device 104 may include a second processor 1044, a second communications module 1042, and a second display module 1046.

According to an embodiment of the invention, the first processor 1024 is communicatively coupled to the first communication module 1022 wherein the first communication module is configured to transmit information, the transmission of information may be through a wireless network not limited to any one of a wi-fi, Bluetooth, near field communication or an infra-red communication network. Furthermore, the first processor 1024 may also be communicatively coupled to the first display module 1026. The first display module 1026 may be an LCD display screen, an LED display screen or any other such display screen as already know in the art.

According to yet another embodiment of the invention the second processor 1044 may be communicatively coupled to the second processor 1042, wherein the second communication module 1042 is configured to receive information from the first communication module 1022. The transmission of information may be through a wireless network not limited to any one of a wi-fi, Bluetooth, near field communication or an infra-red communication network. Furthermore, the second processor 1044 may also be communicatively coupled to the second display module 1046. The second display module 1046 may be an LCD display screen, an LED display screen or any other such display screen as already know in the art.

The first processor 1022 of the transmitting device 102 is configured to perform various steps for transmission of information displayed on the first display module 1026 to the receiving device 104 as described below in the description.

The receiving device 104 may have a software application installed within. The software application may be preinstalled or may be installed by a user from an application store like play store, Appstore etc. The user may preselect his communication preferences or reception mode like what kind of information he wants to receive, what category of information he would like to get, at what time of the day would he like to be communicated, whether the information needs to be stored on a cloud or the receiving device itself, what geographical locations he would like to receive the information at, what type of information mode he would like to receive textual, audio, video, images etc. or a combination of any one the ones mentioned.

The user may also block certain information from being received by indicating the type of information that the user would want not to receive or if received would want purged. By example, in men's fashion the user would not want to receive any information that comes from Ralph Lauren or their subsidiaries. If such information is received it will then be purged by a software seeing program that is part of the receiving device 104. These all choices that the user makes may be known as reception parameters of the receiving device 104.

In another embodiment of the invention the user may also set reception status of the receiving device 104. The reception status of the receiving device 104 may be “receiving mode on” or “receiving mode off”.

The transmitting device 102, through the first processor 1024, is able to identify the receiving device 104 when it is in a proximity to the transmitting device 102. The proximity may be measured by continuous radio burst signals having a particular identification tag that the receiving device 104 may be transmitting, being received by the first communication module 1022. The received identification tag may then be passed on to the first processor 1024 which further determines the reception status of the receiving device 104. Further, the first processor 1024 also reads the plurality of reception parameters as described above, as chosen by the user of the receiving device 104. It also determines, the reception mode of the receiving device 104. After this, the first processor 1024 prepares a content that is to be transmitted to the receiving device 104 based on the reception parameters, reception status and the reception mode of the receiving device 104.

The first processor 1024 then initiates a bisynchronous and secure communication channel with the receiving device 104. The communication channel is generated in between the first communication module 1022 and the second communication module for facilitating communication between the transmitting device 102 and the receiving device 104. After a successful establishment of the communication channel, the content prepared by the first processor 1024 based on the reception parameters and the reception mode is transmitted to the receiving device. Based on the reception mode of the receiving device 104, the content may be then stored in a local memory, sent to a cloud memory or remote memory or even sent to a printer later on when received.

The communication channel may also facilitate ecommerce transactions between the transmitting device 102 and the receiving device 104. In an embodiment of the invention, the receiving device may have a stored payment method like a credit card, e-wall et, etc. for performing the financial transactions. These ecommerce transactions may also be protected by biometrics to make sure that the user's identity is established. User information may also be stored in the transmitting device 102 such that when the transmitting device 102 receives identity information on the user, it may then be able to access other user information including but not limited to users payment information or users psychographic or demographic information such that the transmitting device may be able to make suggestions to the user so as to influence the user's purchases.

In another embodiment of the invention, the communication channel established may facilitate two way communication wherein the user of the receiving device may be able to send some queries related to the content received to the transmitting device and receive answers for it or further information about the products, etc.

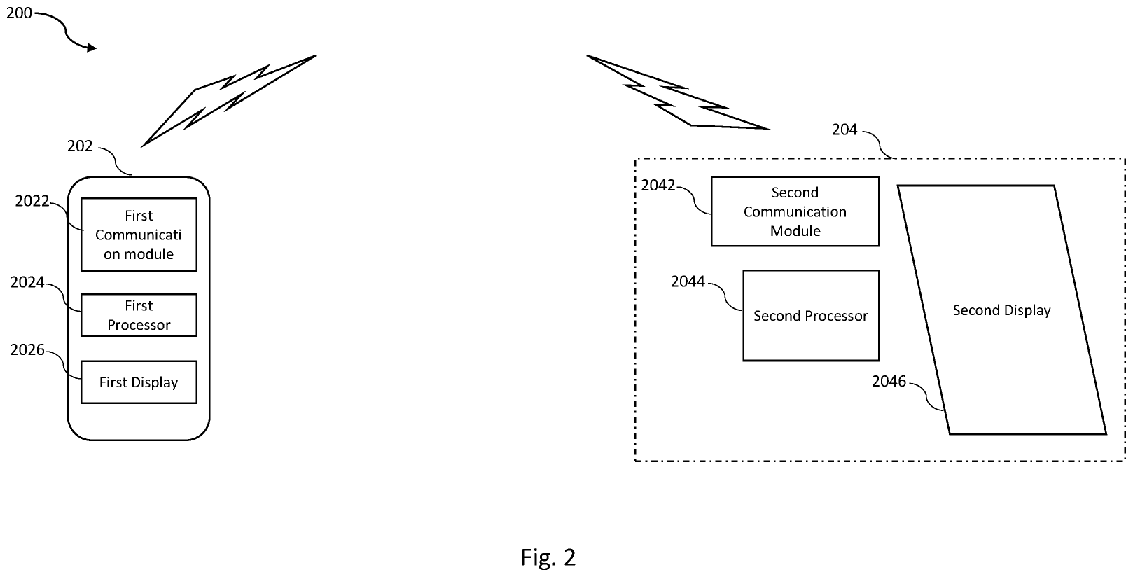

Referring to FIG. 2, a block diagram, illustrates a communication system 200 (referred to as the system 200 hereinafter), in accordance with another embodiment of the invention. The system 200 includes a receiving device 202 and a transmitting device 204. According to an embodiment of the invention, the transmitting device 204 may be a billboard signage or any other means of advertising to general public at a public place or road. According to another embodiment of the invention the receiving device 202 may be any one of a smartphone, a smartwatch, a laptop, an infotainment unit, or a tablet computer.

The receiving device 202 may include a first processor 2024, a first communication module 2022, and a first display module 2026. The transmitting device 204 may include a second processor 2044, a second communications module 2042, and a second display module 2046.

According to an embodiment of the invention, the first processor 2024 is communicatively coupled to the first communication module 2022 wherein the first communication module 2022 is configured to receive information, the reception of information may be through a wireless network not limited to any one of a Bluetooth, near field communication or an infra-red communication network. Furthermore, the first processor 2024 may also be communicatively coupled to the first display module 2026. The first display module 2026 may be an LCD display screen, an LED display screen or any other such display screen as already know in the art.

According to yet another embodiment of the invention the second processor 2044 may be communicatively coupled to the second processor 2042, wherein the second communication module 2042 is configured to transmit information from the first communication module 2022. The transmission of information may be through a wireless network not limited to any one of a wi-fi, Bluetooth, near field communication or an infra-red communication network. Furthermore, the second processor 2044 may also be communicatively coupled to the second display module 2046. The second display module 2046 may be an LCD display screen, an LED display screen or any other such display screen as already know in the art.

The first processor 2022 of the receiving device 202 is configured to perform various steps for reception of information displayed on the second display module 2046 of the transmitting device 204 as described below in the description.

The receiving device 202 may have a software application installed within. The software application may be preinstalled or may be installed by a user from an application store like play store, Appstore etc. The user may preselect his communication preferences or reception mode like what kind of information he wants to receive, what category of information he would like to get, at what time of the day would he like to be communicated, whether the information needs to be stored on a cloud or the receiving device itself, what geographical locations he would like to receive the information at, what type of information mode he would like to receive textual, audio, video, images etc. or a combination of any one the ones mentioned.

The user may also block certain information from being received by indicating the type of information that the user would want not to receive or if received would want purged. By example, in men's fashion the user would not want to receive any information that comes from Ralph Lauren or their subsidiaries. If such information is received it will then be purged by a software seeing program that is part of the receiving device 202. These all choices that the user makes may be known as reception parameters of the receiving device 202.

In another embodiment of the invention the user may also set reception status of the receiving device 202. The reception status of the receiving device 202 may be “receiving mode on” or “receiving mode off”.

The receiving device 202, through the first processor 2024, is able to identify the transmitting device 204 when it is in a proximity to the receiving device 202. The proximity may be measured by continuous radio burst signals having a particular identification tag that the transmitting device 204 may be transmitting, being received by the first communication module 2022. The received identification tag may then be passed on to the first processor 2024 which further determines the transmit status of the transmitting device 204. Further, the first processor 2024 also determines the plurality of reception parameters as described above, as chosen by the user of the receiving device 202. It also determines, the reception mode of the receiving device 202.

The first processor 2024 then initiates a bisynchronous and secure communication channel with the transmitting device 204. The communication channel is generated in between the first communication module 2022 and the second communication module 2042 for facilitating communication between the receiving device 202 and the transmitting device 204. After a successful establishment of the communication channel, the content prepared by the second processor 2024 based on the reception parameters and the reception mode is transmitted to the receiving device 202. Based on the reception mode of the receiving device 202, the content may be then stored in a local memory, sent to a cloud memory or remote memory or even sent to a printer later on when received.

The communication channel may also facilitate ecommerce transactions between the transmitting device 204 and the receiving device 202. In an embodiment of the invention, the receiving device 202 may have a stored payment method like a credit card, e-wallet, etc. for performing the financial transactions. These ecommerce transactions may also be protected by biometrics to make sure that the user's identity is established. User information may also be stored in the transmitting device 204 such that when the transmitting device 204 receives identity information of the user, it may then be able to access other user information including but not limited to users payment information or users psychographic or demographic information such that the transmitting device may be able to make suggestions to the user so as to influence the user's purchases.

In another embodiment of the invention, the communication channel established may facilitate two way communication wherein the user of the receiving device 202 may be able to send some queries related to the content received to the transmitting device 204 and receive answers for it or further information about the products, like reviews, etc.

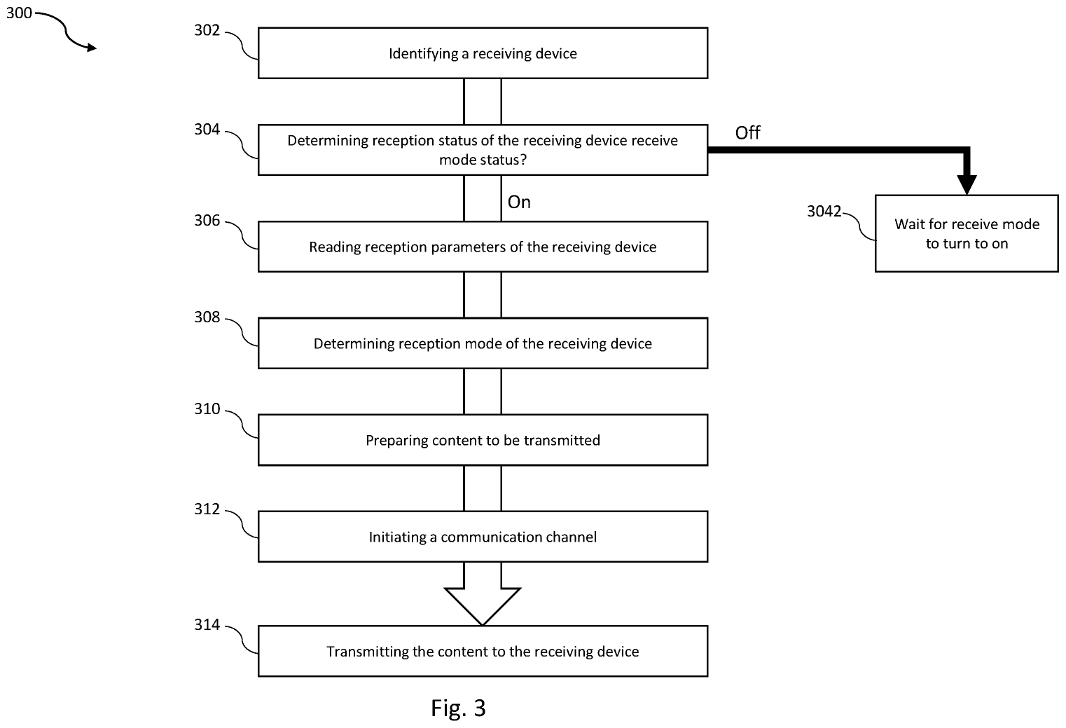

Now referring to FIG. 3, a flow chart indicating a communication method 300, in accordance with an embodiment of the invention.

According to an embodiment of the invention, there may be a software application that may be required to be installed by a user on a receiving device like the receiving device 104 as described in the description in conjunction to FIG. 1. The software application may be also preinstalled within the receiving device 104. The software device may be, but not limited to, an Android based application, an iOS based application, a Windows platform application or any other software platform suitable for today's smartphones. Also, such an application may be installed from applications stores of the respective OS stores of the smartphones like Playstore, Appstore, Windows store etc. The user may register himself within the application for services. He may be able to choose what kind of information he wishes to receive, at what times, in what mode like textual only, audio only, videos only, images only or a combination of these. The user may also choose to receive information only from certain areas only, for example he may choose to receive information only when he passes a certain highway or a certain area like shopping center of a city etc. He may also choose that whether the information is instantly presented, or may be stored in a local or a remote memory to be presented at certain time like during night or may be when in certain geographical location earmarked by him lie home, gym, etc. He may also choose to receive different types of information at different earmarked place. For example, he may wish to information be presented like video information or image information while at home however, he may wish the information would be presented like audio while he is in the gym.

The software application may be configured to continuously transmit identity of the receiving device 104 or continuously check for a signal from the transmitting device 102 through the second communication module 1042.

The method, at step 302, the transmitting device 102 identifies the receiving device 104 by receiving the identification information being transmitted by the second communication module 1042, through its first communication module 1022. The first communication module 1022 and the second communication module 1042 ay be general radio communication transceivers configured to transmit and receive radio signals continuously, or at certain fixed time intervals.

At step 304, the first processor 1024, determines the reception status of the receiving device 104. The reception status, as has been described earlier, would mean that the receiving device is currently in an information receive mode or no. In case, the receive mode is “Off”, then the method 300 moves to step 3042 wherein the method 300 waits for the receive mode to turn to “On”. However, in case the receive mode is “On”, then at step 306, the first processor 1024 checks for the reception parameters set by the user for receiving information for example his choices about information, time, geographical area etc. as disclosed above. At step 308, the first processor 1024 checks for the reception mode of the receiving device 104 like where is the information is to be sent, how is it to be presented etc. as also disclosed earlier within this description. Then, further at step 310, after analyzing the reception parameters, the first processor 1024 checks the information being displayed on the first display module is conforming to the reception parameters of the receiving device or not. If it does, then the first processor 1024 prepares the content to be transmitted to the receiving device 104. Further, at step 312, the transmitting device 102 initiates a secured bisynchronous communication channel with the receiving device 104 to facilitate two-way communication of information to and from the transmitting device 102. At step 314, the content prepared is transmitted to the receiving device 104 in order to be presented to the user may be through the second display module 1046.

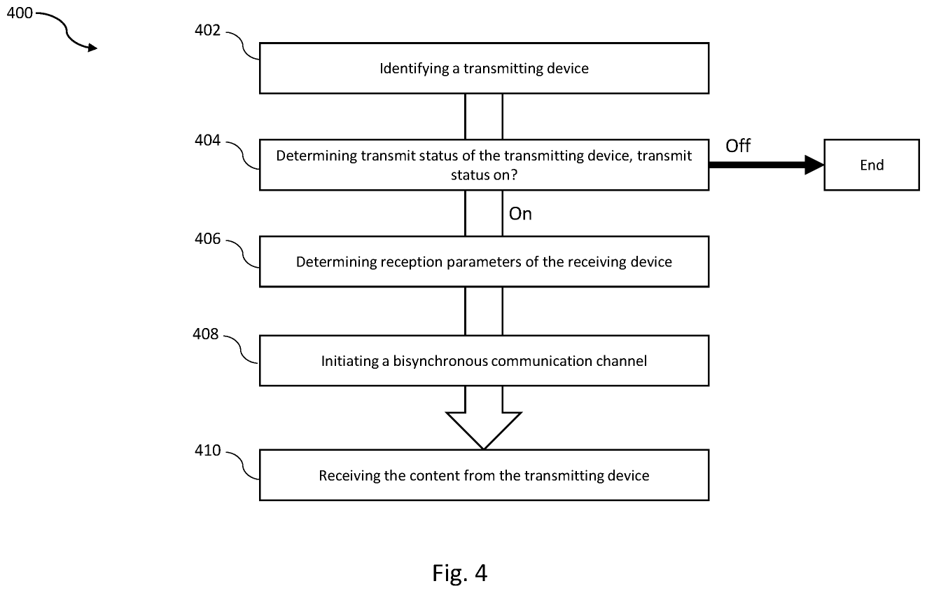

Now referring to FIG. 4, a flow chart indicating a communication method 400, in accordance with an embodiment of the invention.

The method, at step 402, the receiving device 202 identifies the transmitting device 204 within a proximity by receiving the identification information being transmitted by the second communication module 2042, through its first communication module 2022. The first communication module 2022 and the second communication module 2042 ay be general radio communication transceivers configured to transmit and receive radio signals continuously, or at certain fixed time intervals.

At step 404, the first processor 2024, determines the transmitting status of the transmitting device 204. The transmitting status would mean that the transmitting device is currently in an information transmit mode or no. In case, the receive mode is “Off”, then the method 300 ends. However, in case the receive mode is “On”, then at step 406, the first processor 2024 checks for the reception parameters, set by the user, for receiving information for example his choices about information, time, geographical area etc. as has been disclosed above. At step 408, the first processor 2024 initiates a secured bisynchronous communication channel with the transmitting device 204 to facilitate two-way communication of information to and from the transmitting device 204. At step 310, the content is received by the receiving device 202 in order to be presented to the user may be through the first display module 2026.

While certain embodiments have been described, these embodiments have been presented by way of example only, and are not intended to limit the scope of the present disclosure. Indeed, the novel methods, devices, and systems described herein may be embodied in a variety of other forms. Furthermore, various omissions, substitutions, and changes in the form of the methods, devices, and systems described herein may be made without departing from the spirit of the present disclosure. The accompanying claims and their equivalents are intended to cover such forms or modifications as would fall within the scope and spirit of the present disclosure.

It is to be appreciated that the prior art systems do not take care of the surrounding environment and the information of the weapon to perform analytics department. In prior art, information is provided however, no pro-active systems are present that provide sufficient information to the user of such a system in order to support and guide for the usage of the weapon. Also, multiple sensors provide redundant and accurate information to gather usage and further details that help the law enforcement agencies to capture necessary information about the usage of the weapon for proper maintenance of records and instill responsible weapon usage by their users.

1. A communication method comprising:
Identifying, by a transmitting device, a receiving device within a proximate distance;
Determining, by the transmitting device, a reception status of the receiving device;
Reading, by the transmitting device, a plurality of reception parameters of the receiving device;
Determining, by the transmitting device, a reception mode of the receiving device;
Preparing, by the transmitting device, a content to be transmitted to the receiving device based on the reception parameters;
Initiating, by the transmitting device, a communication channel with the receiving device; and
Transmitting, by the transmitting device, the content for the receiving device based on the reception parameters and the reception mode.

2. The communication method of claim 1, wherein the transmitting device is anyone of a billboard, a signage, a television signal.

3. The communication method of claim 1, wherein the receiving device is anyone of a smartphone, an infotainment or information system of a vehicle, a smartwatch, and a tablet computer.

4. The communication method of claim 1, wherein the communication channel is any one of a Bluetooth communication channel, a Wi-Fi communication channel, a Near Field communication (NFC) channel, a cellular communication channel, and an infrared communication channel.

5. The communication method of claim 4, wherein the communication channel is a secured communication channel.

6. The communication method of claim 1, wherein the reception status includes anyone of a receiving on mode or a receiving off mode.

7. The communication method of claim 1, wherein the plurality of reception parameters are set by a user of the receiving device.

8. The communication method of claim 7, wherein the reception parameters are set by the user through an application user interface present in the receiving device.

9. The communication method of claim 7, wherein the plurality of reception parameters includes user choices for information to be received.

10. The communication method of claim 9, wherein the user choices includes category of information, geographic locations to receive information, or type of information.

11. The communication method of claim 10, wherein the type of information includes anyone or a combination of a text information, an audio information, an email information, an image information, a virtual reality information, and a software program for later usage.

12. The communication method of claim 1, wherein the reception mode is any or a combination of a reception on mobile, a reception of information to be stored in a memory local or cloud based, or a reception of information to be sent to a printer.

13. The communication method of claim 1, wherein the communication channel facilitates ecommerce transactions.

14. The communication method of claim 1, wherein the receiving device is capable of communicating back with the transmitting device for further information requests.

15. The communication method of claim 1, wherein the communication is in an encrypted format.

16. A communication system comprising;
A transmitting device, wherein the transmitting comprises:
A first processor;
A first communication module, communicatively coupled to the first processor, and configured to transmit an information;
A first display module, communicatively coupled to the first processor, and configured to display the information to an audience;
A receiving device, wherein the receiving device comprises:
A second processor;
A second communication module, communicatively coupled to the second processor, and configured to communicate with the first communication module
A second display, communicatively coupled to the second processor to display the information received from the transmitting device;
Wherein the first processor is configured to carry out the steps of;
Identifying the receiving device within a proximate distance;
Determining a reception status of the receiving device;
Reading a plurality of reception parameters of the receiving device;
Determining a reception mode of the receiving device;
Preparing a content to be transmitted to the receiving device based on the reception parameters;
Initiating a communication channel with the receiving device; and
Transmitting the content to the receiving device based on the reception parameters and the reception mode.

17. The communication system of claim 15, wherein the transmitting device is anyone of a billboard, a signage, a television signal.

18. The communication system of claim 15, wherein the receiving device is anyone of a smartphone, an infotainment or information system of a vehicle, a smartwatch, and a tablet computer.

19. The communication system of claim 15, wherein the communication channel is any one of a Bluetooth communication channel, a Wi-Fi communication channel, a Near Field communication (NFC) channel, a cellular communication channel, and an infrared communication channel.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A communication system comprising;
A receiving device, wherein the receiving device comprises:
A first processor;
A first communication module, communicatively coupled to the first processor, and configured to transmit an information;
A first display module, communicatively coupled to the first processor, and configured to display the information to a user;
A transmitting device, wherein the transmitting device comprises:
A second processor;
A second communication module, communicatively coupled to the second processor, and configured to communicate with the first communication module
A second display, communicatively coupled to the second processor to display the information to an audience;
Wherein the first processor is configured to carry out the steps of Identifying the transmitting device within a proximate distance; Determining a transmit status of the transmitting device;
Determining a plurality of reception parameters of the receiving device;
Determining a reception mode of the receiving device;
Initiating a bisynchronous communication channel with the transmitting device; and
Receiving the content from the transmitting device based on the reception parameters and the reception mode.
